(19) United States
(12) Patent Application Publication
(10) Pub. No.: US 2011/0015943 A1
(43) Pub. Date: Jan. 20, 2011

(54) COMPREHENSIVE METHOD AND SYSTEM FOR INTAKE SCREENING AND MEDICAL RECORDS MANAGEMENT

(76) Inventors: Carl Keldie, Brentwood, TN (US); Stephen Hernandez, Brentwood, TN (US); Jeffrey Johnson, White Bluff, TN (US); Julie Hirshburg Pine, Murfreesboro, TN (US); Constance Thran, Franklin, TN (US)

Correspondence Address: ARENT FOX LLP, 1050 CONNECTICUT AVENUE, N.W., SUITE 400, WASHINGTON, DC, 20036, US

(21) Appl. No.: 12/895,231

(22) Filed: Sep. 30, 2010

Related U.S. Application Data
(63) Continuation-in-part of application No. 12/130,604, filed on May 30, 2008.
(60) Provisional application No. 60/924,791, filed on May 31, 2007.
(60) Provisional application No. 60/924,792, filed on May 31, 2007.

(51) Int. Cl. G06Q 50/00; G06F 15/16

(52) U.S. Cl. 705/2; 709/206

(57) ABSTRACT

A system and method for providing health care services, such as medical intake screening and follow-up patient care, including management of medical records and access to patient information for incarcerated individuals. Data regarding medical information collected during an initial intake and screening process and subsequent physical examination may be inputted into a data repository. Triggers based upon the specific data entered may generate alerts for follow up medical care.

### CROSS-REFERENCE TO RELATED APPLICATIONS

This application is a continuation-in-part of U.S. patent application Ser. No. 12/130,604, filed on May 30, 2008, which claims priority the following applications: U.S. Provisional Application No. 60/924,792, titled “Method and System for Intake Screening and Medical Records Management,” filed on May 31, 2007; and U.S. Provisional Application No. 60/924,791, titled “Comprehensive Method and System for Intake Screening and Medical Records Management,” filed on May 31, 2007. Each of the prior applications are incorporated by reference herein in its entirety.

### BACKGROUND OF THE INVENTION

1. Field of the Invention

The present invention relates to methods and systems for providing health care services, such as medical intake screening and follow-up patient care, including management of medical records and access to patient information during subsequent screening. Specifically, the present invention is directed to providing intake screening and medical records management for incarcerated individuals located at various sites.

2. Description of Related Art

One problem that exists in the art today is that the initial intake screenings of incarcerated individuals, which are performed by a variety of clinical personnel, have a high variation in the clinical procedures used, the timing of the intake, and the clinical skill of the personnel performing the intake, among other factors. In addition, many facilities use paper-based, primarily manual systems to perform the intake procedures. This approach often leads to difficulties with subsequent patient treatment, and particularly with providing accurate and up-to-date health information to medical practitioners at the point of care, to ensure appropriate and timely follow-up health care services, if needed.

There is a need in the art, therefore, for a method and system that provides streamlined uniform initial medical intake screening and follow-up patient care procedures, with little or no variation in the clinical procedures used, the timing of the intake, and the clinical skill of the personnel performing the intake. In addition, there is a need for a method and system for medical intake screening and follow-up patient care, based on secure electronic storage of information, which would ensure timely and secure access to patient information, both during the intake process and for subsequent patient treatment.

The National Commission for Correctional Health Care (NCCHC) and the American Correctional Association (ACA) are two governing bodies that provide procedures and recommendations for health care services for incarcerated individuals. Thus, there is a need in the art, for a method and system that provides streamlined uniform initial medical intake screening and follow-up medical treatment in the context of the guidelines and recommendations for health care services for incarcerated individuals.

### SUMMARY OF THE INVENTION

The present invention solves the above-identified needs, and others, by providing methods and systems that include streamlined uniform initial medical intake screening and follow-up patient care procedures, with little or no variation in the clinical procedures used, the timing of the intake, and the clinical skill of the personnel performing the intake. In addition, the present invention provides methods and systems for medical intake screening and follow-up patient care, based on secure electronic storage of information, to ensure timely and secure access to patient information, both during the intake process and for any subsequent patient treatment. Further, the present invention provides methods and systems in accordance with the guidelines and recommendations for health care services for incarcerated individuals.

In one exemplary aspect, the present invention is based on an open system architecture, comprising an Administrative Unit, a Patient Search Unit, an Intake Screening Unit, a History and Physical Examination Unit, an Automated Patient Summary Unit, and a Forms and Reports Unit.

The Administrative Unit serves to manage contract information, pick lists, user information, and role security. The Patient Search Unit facilitates locating patient health records (currently admitted or previously discharged). The Intake Screening Unit facilitates electronic documentation of the initial intake examination. The History and Physical Examination Unit facilitates complete documentation of the history/physical examinations. The Automated Patient Summary Unit provides a summary of current patient clinical problems, allergies, medications, and appointments. The Forms and Reports Unit provides a uniform system of forms and reports for use by the system, e.g., clinical and scheduling forms and reports for inclusion in the medical record.

In an aspect of the present invention, after an individual is brought to the healthcare personnel, an initial intake and screening of medical information may be performed for the individual. During the initial intake and screening process, an individual may be assessed for any immediate health concerns that may need expedited medical attention. If the individual needs immediate medical attention, the intake screening process can be stopped and the appropriate medical treatment may be administered. The intake process may be completed after the individual has received the appropriate medical treatment. If the individual does not need immediate medical attention, the intake process continues. Specific data regarding the medical information collected during the initial intake and screening process may be inputted into a centralized data repository. Triggers based upon the specific data entered may generate alerts for follow up activities. These alerts may ensure consistent follow up activities and may help guide a physician through a clinical examination.

Next, the individual may undergo a history and physical examination. The history and physical examination may be conducted seven to fourteen days, for example, after the initial intake and screening process and may include more in depth questions regarding the individual's medical history. Specific data may be entered into a data repository in response to questions asked during the history and physical examination. It may be possible to create triggers based upon the specific data entered to generate alerts for follow up activities.

A comprehensive diagnosis for the individual may be provided after the initial intake and screening process and the history and physical examination are completed. The comprehensive information may include a problem list, allergies, upcoming appointments and current medications, among others.

Once the information regarding an individual has been entered, the user may search for an individual based upon a unique identification number. This identification number may include a state ID number, a booking number or any other number that might uniquely identify the individual. The user may create and print reports based upon parameters the user specifies.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various exemplary aspects of the systems and methods will be described in detail, with reference to the following figures, wherein:

FIG. 1 presents an exemplary system diagram of various hardware components and other features, for use in accordance with an aspect of the present invention;

FIG. 2 is a block diagram of various exemplary system components, in accordance with an aspect of the present invention;

FIG. 3 presents an example flow diagram of functions performed in accordance with aspects of the present invention;

FIG. 4 is an example of performing intake in accordance with one aspect of the present invention;

FIG. 5 is an example of generating alerts in accordance with one aspect of the present invention;

FIG. 6 is an example of performing a history and physical examination in accordance with one aspect of the present invention;

FIG. 7 is an example of providing comprehensive diagnosis in accordance with an aspect of the present invention;

FIG. 8 is an example of searching for an individual in accordance with an aspect of the present invention;

FIG. 9 presents an example flow diagram of functions performed in accordance with aspects of the present invention;

FIG. 10 presents an example of adding medications to the medication list for an individual in accordance with aspects of the present invention;

FIG. 11 presents an example flow diagram for ordering medication in accordance with aspects of the present invention;

FIG. 12 is an example of ordering medication in accordance with an aspect of the present invention;

FIG. 13 is an example flow diagram for ordering a diagnostic test for an individual in accordance with an aspect of the present invention;

FIG. 14 is an example of adding a diagnostic test to a patient record in accordance with aspects of the present invention; and

FIG. 15 is an example of inputting results of a diagnostic test to a patient record in accordance with aspects of the present invention.

### DETAILED DESCRIPTION OF ASPECTS OF THE PRESENT INVENTION

These and other features and advantages of this invention are described in, or are apparent from, the following detailed description of various exemplary aspects of the present inventions.

The present invention may be implemented using a centralized data repository which can be accessed through a web-based interface that allows the user to access data regarding an individual's health care. Storing the information centrally may allow for easy retrieval of the information from any facility that has broadband Internet or other means of access. Additionally, implementing changes in code, upgrading the system, having ability to benchmark facilities, and various system supports may be performed easier using a centralized data repository.

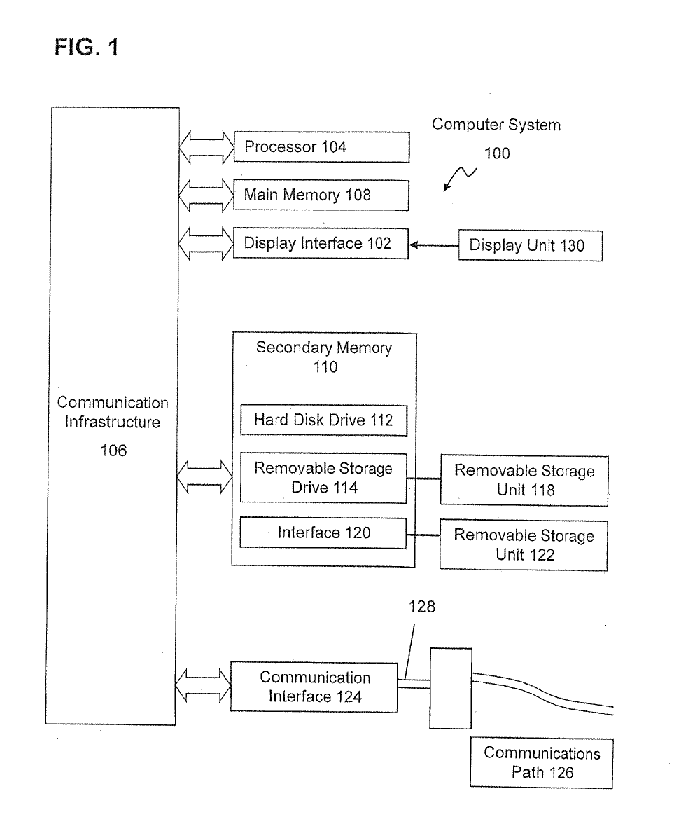

The present invention may be implemented using hardware, software, or a combination thereof and may be implemented in one or more computer systems or other processing systems. In one aspect, the invention is directed toward one or more computer systems capable of carrying out the functionality described herein. An example of such a computer system 100 is shown in FIG. 1.

Computer system 100 includes one or more processors, such as processor 104. The processor 104 is connected to a communication infrastructure 106 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 100 can include a display interface 102 that forwards graphics, text, and other data from the communication infrastructure 106 (or from a frame buffer not shown) for display on a display unit 130. Computer system 100 also includes a main memory 108, preferably random access memory (RAM), and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

In alternative aspects, secondary memory 110 may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 114, a hard disk installed in hard disk drive 112, and signals 128. These computer program products provide software to the computer system 100. The invention is directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features of the present invention, as discussed herein. In particular, the computer programs, when executed, enable the processor 110 to perform the features of the present invention. Accordingly, such computer programs represent controllers of the computer system 100.

In an aspect where the invention is implemented using software, the software may be stored in a computer program product and loaded into computer system 100 using removable storage drive 114, hard drive 112, or communications interface 120. The control logic (software), when executed by the processor 104, causes the processor 104 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

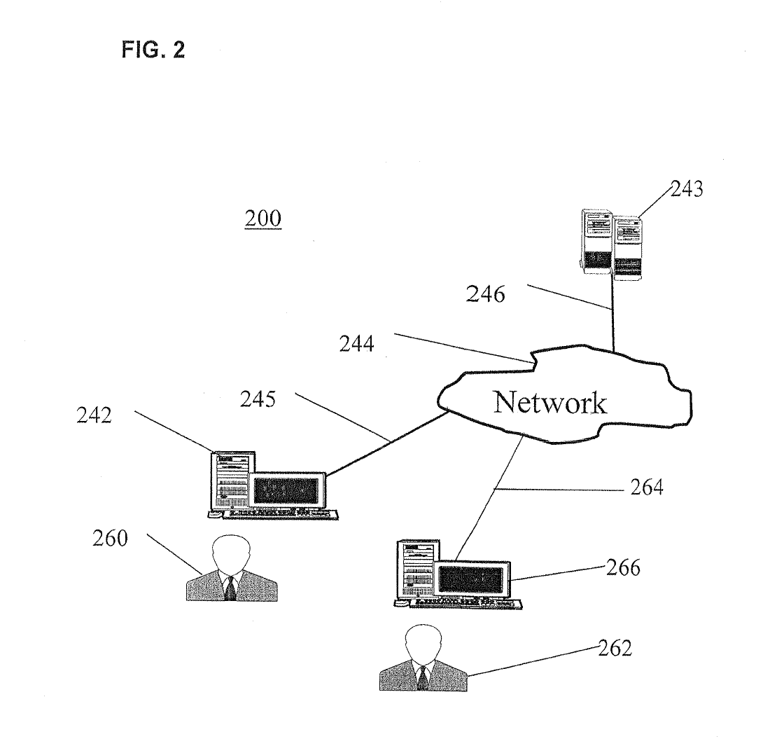

FIG. 2 shows a communication system 200 usable in accordance with the present invention. The communication system 200 includes one or more accessors 260, 262 (also referred to interchangeably herein as one or more “users”) and one or more terminals 242, 266. In one aspect, data for use in accordance with the present invention is, for example, input and/or accessed by accessors 260, 264 via terminals 242, 266, such as personal computers (PCs), minicomputers, mainframe computers, microcomputers, telephonic devices, or wireless devices, such as personal digital assistants (“PDAs”) or a hand-held wireless devices coupled to a server 243, such as a PC, minicomputer, mainframe computer, microcomputer, or other device having a processor and a repository for data and/or connection to a repository for data, via, for example, a network 244, such as the Internet or an intranet, and couplings 245, 246, 264. The couplings 245, 246, 264 include, for example, wired, wireless, or fiberoptic links. In another aspect, the method and system of the present invention operate in a stand-alone environment, such as on a single terminal.

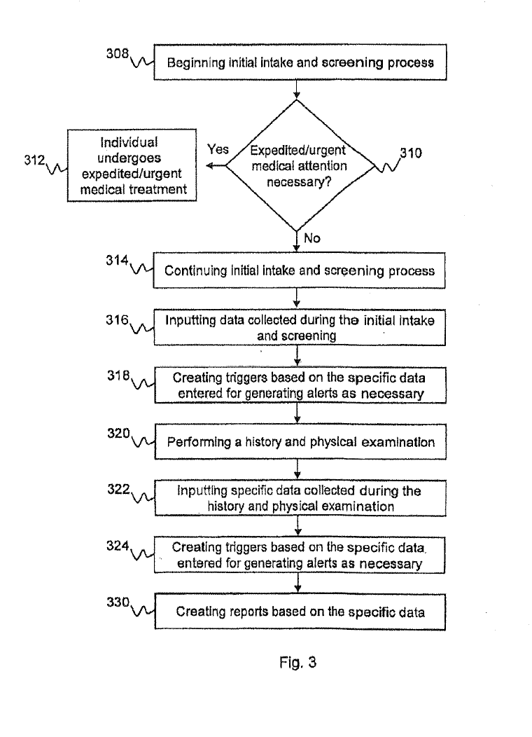

An example flow diagram 300 of functions performed in accordance with an aspect of the present invention will now be described in conjunction with FIG. 3. Once an individual has been sentenced by the court, transferred from another facility, or otherwise incarcerated, the individual may be brought to the healthcare personnel at the facility.

After being brought to the healthcare personnel, an initial intake and screening of medical information may be performed for the individual 308. During the initial intake and screening process, an individual may be assessed for any immediate health concerns that may need expedited medical attention 310. If the individual needs immediate medical attention, the intake screening process can be stopped and the appropriate medical treatment may be administered to the individual 312. After the individual has received the medical treatment, the initial intake process may be completed. If the individual does not need immediate medical attention, the intake process can continue until completed 314.

Specific data regarding the medical information collected during the initial intake and screening process may be inputted into a data repository 316 and may be correlated with a unique identifier for the incarcerated individual. Entering in specific discrete data in response to specific questions can provide a consistent intake and screening process. Further, it may be possible to create triggers based upon the specific data entered to generate alerts for follow-up and other activities 318. These alerts may ensure consistent follow-up activities and may help guide a physician through a clinical examination.

If the intake and screening process is not completed, then a screening status may be associated with the intake and/or screening for the individual. A screening status may include, for example, the status of ready to begin; in progress (e.g., the screening has been started but has not been completed); on hold (e.g., the screening has been placed on hold and has not been completed); incomplete (e.g., the patient was released prior to the screening being completed) or refused (e.g., the patient refused to have the screening performed). Additional comments may be provided to explain the screening status, such as “on hold due to a mental health problem” or “unable to complete the screening because the facility went into lockdown.” Thus, the user may be able to view the status of the screening and/or additional comments to understand why an intake and/or screening process was not performed/completed. In an aspect, if a patient refuses the intake and screening process, a refusal form may be generated and printed for the patient's signature. If the patient, however, does not sign the refusal form at this time, an alert may be generated to print the refusal form at a later time for the patient's signature.

Moreover, a reference category may be associated with the intake and screening for an individual patient. Reference categories may include, for example, whether the screening was generated automatically by the system, whether the screening was completed on paper and can be found in the patient's chart, or whether the screening was from a past record (e.g., the patient transferred from another facility; was a parole violator coming back to the correctional facility; a housing change; or a chart carried forward from a previous incarceration). Thus, the system may track the origin of the intake and screening process.

The individual may undergo a history and physical examination 320 seven to fourteen days after the initial intake and screening process. The history and physical examination may include more in depth questions regarding the individual's medical history. Specific data may be entered into a data repository in response to questions asked during the history and physical examination 322, again correlated with the unique identifier for the incarcerated individual. In addition, it may be possible to create triggers based upon the specific data entered to generate alerts for follow up activities 324. These alerts may ensure consistent follow up activities and may help guide a physician through a clinical examination.

A comprehensive medical history and/or diagnosis for the individual may be provided after the initial intake and screening process and after the history and physical examinations are completed. For example, an automatic patient summary may provide comprehensive information regarding the individual. The information may include a problem list, allergies, upcoming appointments and current medications, among others.

Once information regarding an individual has been entered, the user may search for an individual based upon a unique identifier or identification number. This identification number may include a state ID number, a booking number or any other number that might uniquely identify the individual. In addition, a user may search for an individual based upon, for example, an individual's gender, facility location, admission date, discharge date, race, housing location, and/or a photograph of the individual, such as a mugshot. Additionally, the user may create and print reports based upon specified parameters 330.

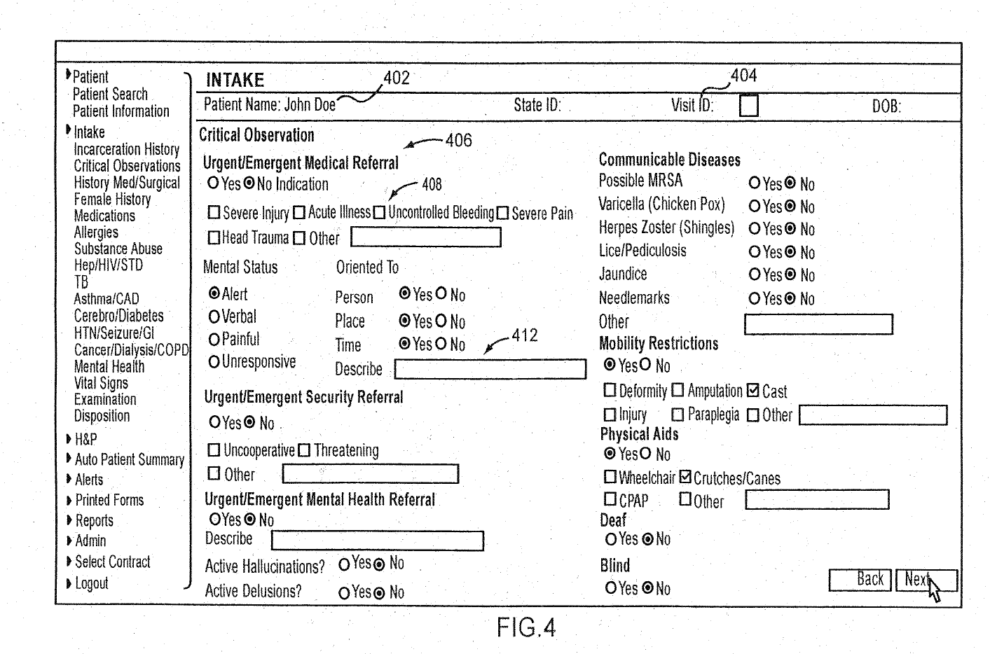

The intake and screening process 308 is presented in more detail in FIG. 4, in accordance with an aspect of the present invention. Individual 402 may be assessed for immediate health concerns, chronic conditions, infectious diseases, mental illnesses, or any issues that may harm individual 402 or others. If individual 402 needs medical attention, the intake screening process may be stopped and individual 402 can be given the appropriate medical treatment. The intake process may be completed after individual 402 has received the appropriate medical treatment. If individual 402 does not need immediate medical attention, the intake process may continue.

During the initial intake and screening process, categories of intake may be conducted for individual 402 including critical observations, history, mental health, vital signs, examinations and dispositions, among others. Critical Observations questions may be used to identify urgent or emergent medical needs. The History section questions may be used to get a basic healthcare history including any recent hospitalizations, allergies, current prescriptive medications, substance abuse, communicable diseases, and chronic illnesses, among others. A Mental Health section includes questions regarding the patient's mental status. The Vital Signs section records information including blood pressure, respiration, height and weight, among others. An Examination section records general appearance, oral cavity, and skin observations. The Disposition section may contain recommendation for placement in the jail or prison, confirmation that policies were reviewed, and referral information, among others.

Referring now to FIG. 4, individual 402 may have a Visit ID 404 which uniquely identifies individual 402 and allows information relating to individual 402 to be located and associated with individual 402. Visit ID 404 may be, for example, a booking number or a prison number, among others. In addition, individual 402 may also have a mugshot displayed in the data repository for identifying individual 402. Specific data in response to questions asked during the initial intake may be inputted into a data repository.

In general, every question in the intake process should have an answer. But if the questions 406 do not apply to individual 402, answer blocks 408 may be grayed out so the user does not need to enter answers in response to those questions. However, if the questions do apply to individual 402, additional questions may be asked based upon the responses provided by individual 402. For example, if individual 402 indicates the individual has mental health issues, additional questions may be asked regarding whether they have hallucinations or other delusions, among others. Thus, it should be appreciated that the questions may be configured and dynamically provided based upon responses to previous questions. Additionally, individual 402 may be expedited for further mental health consultations based upon the response to the initial and/or additional questions.

Further, in an aspect of the present invention, the questions may require specific answers. The answers may include a drop-down list providing a list of available answers, yes or no buttons 410, or the user may need to enter the answer in the required field 412. It should be appreciated that the questions may be varied based upon individual 402. For example, there may be different questions depending on whether individual 402 is a male, female or juvenile, among others.

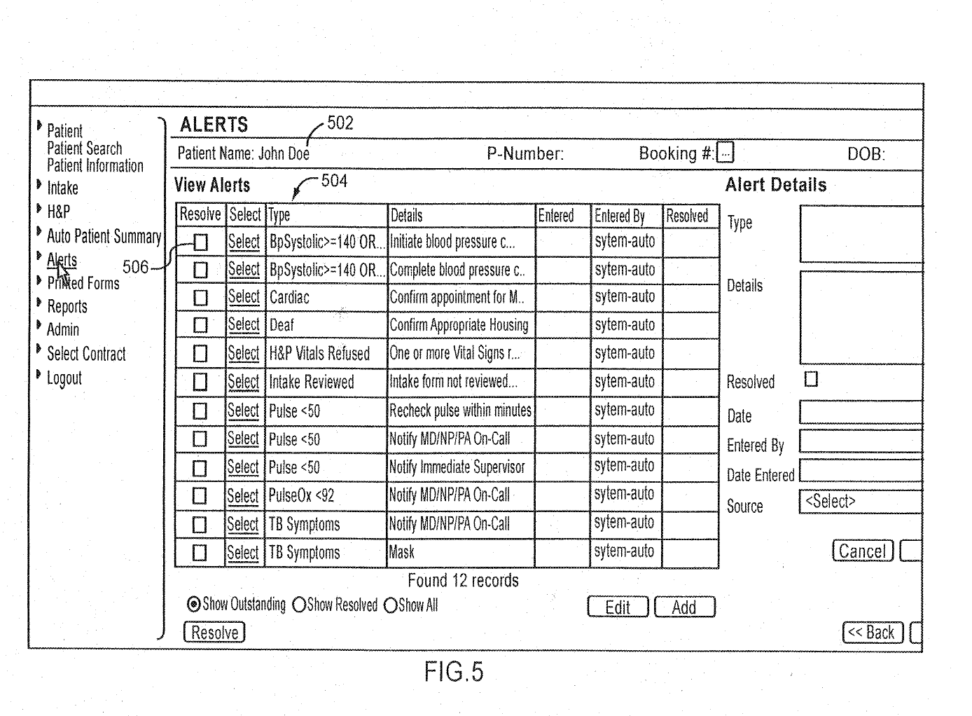

Further, in an aspect of the present invention it may be possible to automatically create triggers based upon the specific data entered to generate alerts for follow up activities for individual 402. For example, if individual 402 indicates a diabetes diagnosis, the system may automatically trigger an alert for an expedited specialized follow up instead of a routine follow up. Alternatively, the user may manually enter the alert for an expedited specialized follow up. Other pre-defined triggers may include the ability of the system to automatically add a lab or image alert, automatically order a lab and/or image diagnostics, automatically add and/or order new medication, automatically add an appointment, and automatically add printed forms, among others. It should be appreciated that the user may add the pre-defined triggers for the alerts as well. The alerts, according to an aspect of the present invention, are presented in more detail in FIG. 5.

Referring now to FIG. 5, after the initial intake and screening process is completed, alerts 504 for clinically significant events may be created based upon data entered during the initial intake and screening process. In an aspect of the present invention, alerts 504 may be created automatically based upon a pre-defined trigger, may be created by the system user through a pre-defined trigger, or may be otherwise entered. In an aspect of the present invention, the alerts may include additional medical procedures, laboratory testing and imaging, follow up appointments, prescribing medication to individual 502, or calling a physician for immediate assistance, among others. Alerts 504 may ensure consistent follow up activities and may help guide a physician through a clinical exam.

In an aspect of the present invention, the list of alerts 504 may be sorted by clicking on the column headings above each column. For example, alerts 504 may be sorted by type, details, date the alert was entered and how the alert was entered, among others. Once an alert has been resolved by the user, the user checks or otherwise clears resolved box 506.

After completion of the initial intake process and screening, a history and physical exam may be conducted. The history and physical exam at most sites may be completed 7 to 14 days after the initial intake screening process. In an aspect of the present invention, a new history and physical can be created or an existing history and physical may be viewed after selecting an individual. It should be appreciated that the history and physical exam may be conducted by a different entity than the initial intake process and screening.

The history portion of the exam, for example, may contain two categories: medical/surgical and mental. The medical and surgical section may include, but is not limited to, recent hospitalizations, female history, current prescriptive medications, tobacco, substance abuse, communicable diseases, and chronic illnesses. The mental health section may ask a variety of mental health questions.

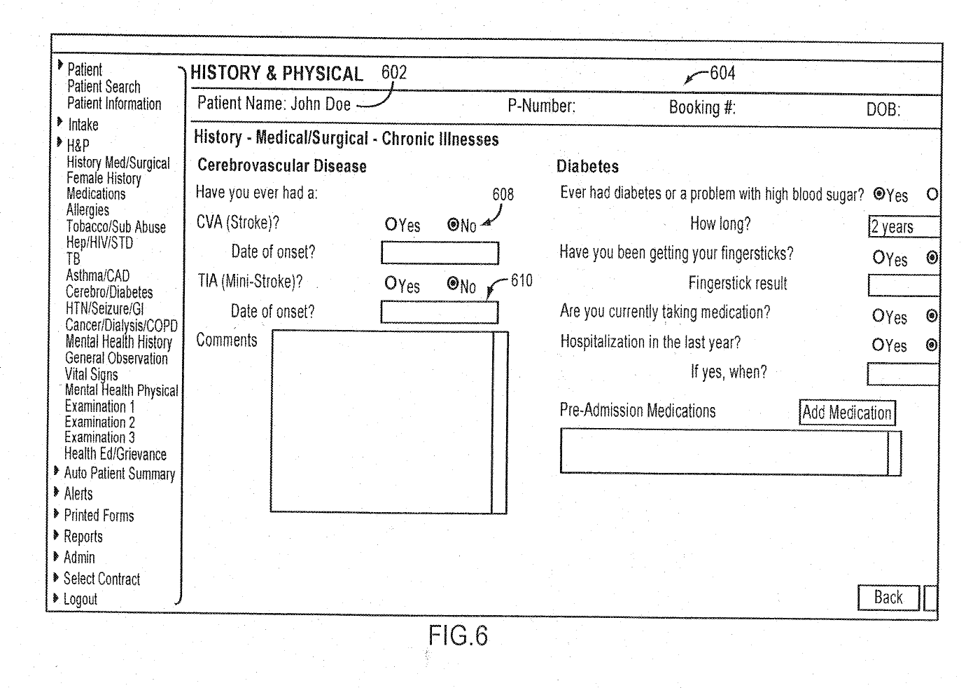

In the Physical portion of the history and physical, there may be the following subsections: General Observation, Vital Signs, Mental Health, Examination, Health Education, Grievance Process, Additional Comments, and Signature, among others. The General Observation subsection can contain, for example, questions about mobility restrictions, physical aids, and the senses. A Vital Signs subsection can include, but is not limited to, information about blood pressure, respiration, height and weight. In the Mental Health subsection there can be questions about mental status. Examination subsection contains physical examination questions about major body systems, among others. The Health Education subsection may include provided health related educational material. A Grievance Process subsection may be included to ensure that the grievance process has been explained to the patient. An Additional Comments subsection may be provided for recording any additional comments. Finally, in the Signature subsection the patient agrees to medical assistance and the person performing the history and physical signs. In an aspect of the present invention, the signature subsection may be done by recording the user id of the person performing the history and physical and printing a form at a later time to get the individual's signature. The history and physical exam is presented in more detail in FIG. 6.

Referring now to FIG. 6, the individual 602 may be asked more in depth questions regarding their medical history and family medical history. Every question asked during the history and physical examination should have an answer. However, if the questions do not apply to individual 602, the answers may be grayed out so the user does not need to enter responses to those questions. Further, the questions may be directed to specific answers. It should be appreciated the questions can be varied for various individuals. For example, different questions may be asked to males, females and juveniles, among others. The answers may include drop-down lists providing the available responses, selecting either yes or no buttons 608 or the user may need to enter in a value in the appropriate field 610. In addition, it may be possible to create triggers based upon the specific data entered to generate alerts for follow up activities. These alerts may ensure consistent follow up activities.

Further, in an aspect of the present invention it may be possible to automatically create triggers based upon the specific data entered to generate alerts for follow up activities for individual 602. Other pre-defined triggers may include the ability for the system to automatically add a lab or image alert, automatically add an appointment, and automatically add printed forms, among others. It should be appreciated that the user may add the pre-defined triggers for the alerts as well. The alerts according to an aspect of the present invention are presented in more detail in FIG. 5.

It will be understood by those of ordinary skill in the art, that for previously incarcerated individuals, the initial intake and screening process will have been completed, and subsequent routine and/or scheduled physicals/exams may be conducted by following steps 320-330.

Referring now to FIG. 5, in an aspect of the present invention, after the completion of the history and physical examination, alerts 504 for clinically significant events may be created based upon data entered during the history and physical examination. It should be appreciated that alerts 504 may be created automatically based upon a pre-defined trigger or may be created by the system user through a pre-defined trigger, or otherwise entered by the user. In an aspect of the present invention, the alerts may include additional medical procedures, laboratory testing and imaging, follow up appointments, prescribing medications to individual 502, or calling a physician for immediate assistance, among others. Alerts 504 may ensure consistent follow up activities and may help guide a physician through a clinical exam.

In an aspect of the present invention, the list of alerts 504 may be sorted by clicking on the column headings above each column. For example, alerts 504 may be sorted by type, details, date the alert was entered and how the alert was entered by, among others. Once an alert has been resolved by the user, the user may check or otherwise clear the resolved box 506.

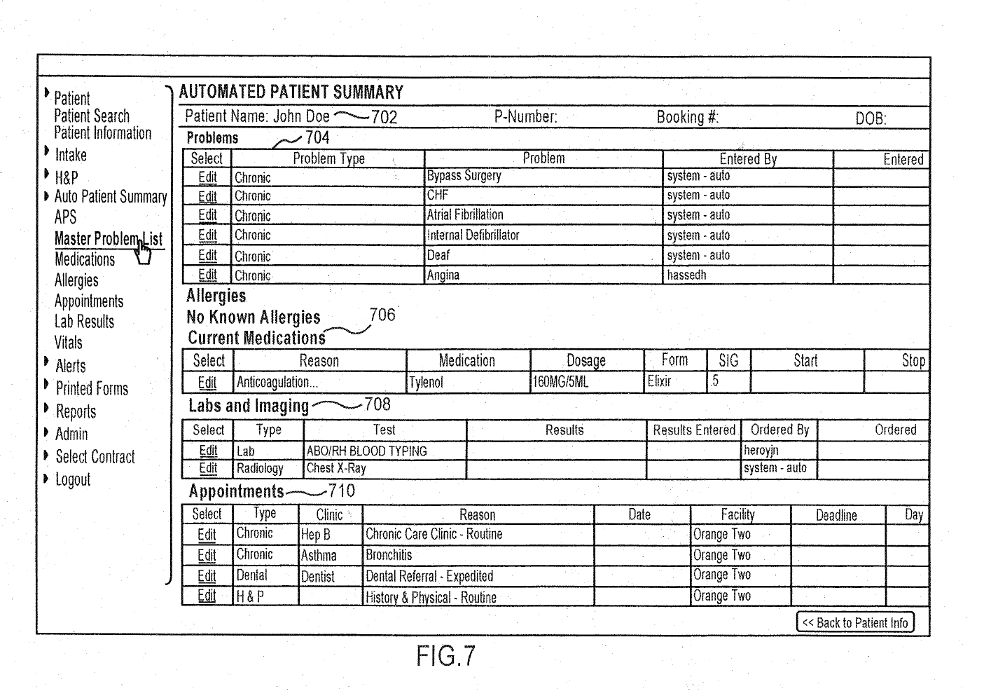

An aspect of the present invention may include a comprehensive medical history and/or diagnosis for the individual after the initial intake and screening process and history and physical examination are completed. For example, an automatic patient summary may provide comprehensive information regarding the individual in a central location. An automated patient summary according to an aspect of the present invention are presented in more detail in FIG. 7.

Referring now to FIG. 7, the automated patient summary report may include but is not limited to, a master problem list 704, allergies 706, labs and imaging 708, upcoming appointments 710, and current medications, among others. The automated patient summary may be accessible after choosing individual 702 and the completion of the initial intake and screening process. Each list may allow the user to go directly to the information contained in the list. For example, a user can click on a medication in the medications list and go to the medications screen with the selected medication's detailed information.

The master problem list 704 for individual 702 may record medical problems gathered during and after the initial intake and screening process or the history and physical examination and/or other physical examination, as applicable. Individual 702 and an intake screening or history and physical may be selected to access the problem list 704. Problem list 704 may include a list of problems and provide capability to see a detailed problem view and add new problems. Additionally, problems may be automatically or manually added through the use of a pre-defined trigger. It should further be appreciated that lab test, images, appointments, and medications can be associated with a problem. This association may be performed manually or automatic. The user may mark problems as resolved or otherwise clear the problem upon resolution of the problem.

In an aspect of the present invention, the allergies portion 706 may track allergies identified during the initial intake and screening process and/or the history and physical examination. An emphasis may be placed on life threatening allergies and significant medication allergies. Allergies can be identified by the type of allergy, for example, medication or environmental, among others. Additionally, the reaction that occurs for this allergy may be noted along with information on the allergy itself, for example, allergic to mold, may be recorded. Allergies 706 are tied to individual 702, therefore, individual 702 and an intake screening or history and physical can be selected to access allergy information for individual 702.

Additionally, allergies 706 can be marked as inaccurate to indicate that an allergy was entered in error. However, an allergy cannot be deleted or removed. There may be a predefined list of allergies from which the user can select. In addition, the user may select “other,” usually the last option, and enter any non-listed allergy. Further, the user may add additional comments. In an aspect of the present invention, a user may generate a report showing all medication allergies for a patient. A report may show, for example, all individuals currently at the site who have had an anaphylactic reaction to a medication or environmental allergen. It should be appreciated that this report may be modified to show a user-specified medication or environmental allergen.

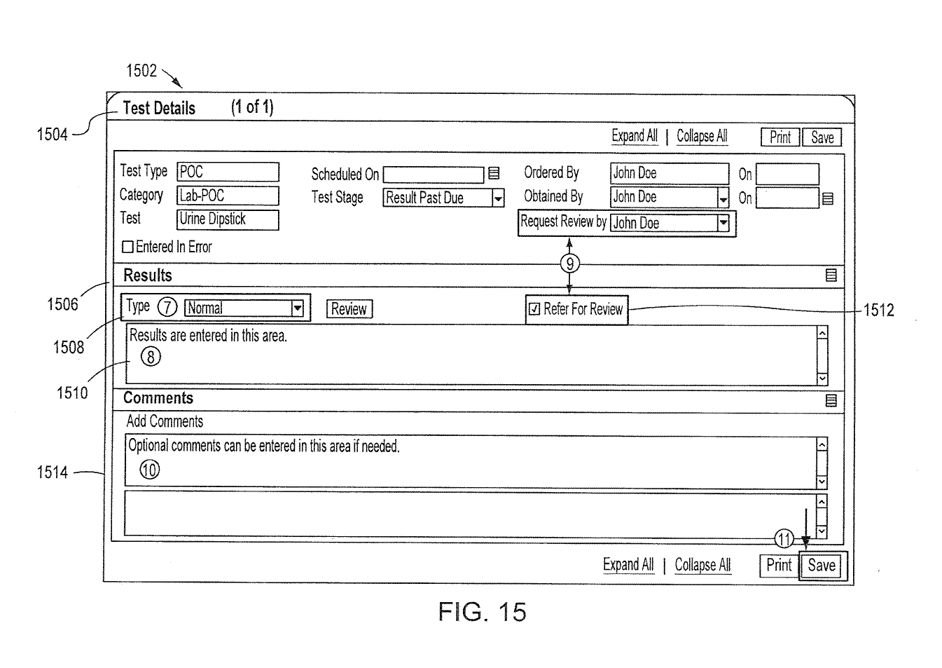

In an aspect of the present invention, the labs and imagining 708 may record any labs and images ordered during the initial intake and screening process or the history and physical examination. The results of the labs once complete may be manually entered or may be sent in digital form from the lab. In an aspect, the results of the labs may be automatically inputted into the patient record, as discussed below in reference to FIG. 15. In order to view, add, or modify labs and imaging information the user may select an individual 702. Information that may be requested for each lab or image includes: the type (lab or radiology); the name of the test; results of the test; and data on who ordered the test and when, among others. It should be appreciated that there may be a general list of labs and images that have been ordered and the details of a particular lab or image may be accessed from the list. Additionally, an appointment may be added from the detailed view. Other functions in the detailed view may include the ability to indicate that a lab or image was not required, or was refused by the patient. Further, new labs and image orders can be added from a list in the system of labs and images.

Another aspect of the present invention may include any appointments 710 scheduled during the initial intake and screening process or the history and physical examination. In addition, sick calls and chronic care follow-ups after intake can be scheduled. Scheduling may be accessed from either the patient information screen or the intake history screen. In order to retrieve scheduling information, individual 702 may be selected. It should be appreciated that there may be a list of appointments that have been scheduled for individual 702 from which the user can choose an appointment 710 and see a detailed view. The detailed view may allow the user to update or add information such as: disposition of the appointment (i.e. pending, seen, rescheduled, etc.); designate an appointment as critical; and reschedule the appointment, among others. Further, new appointments may be added from the appointment list. Appointments may also be automatically or manually added by the system using a pre-defined trigger

In addition, the user may search for appointments that have been scheduled for individual 702. For example, the user may search based upon an individual's name; an individual's status (e.g., active or released), clinic type; clinician type (e.g., doctor or nurse practitioner); appointment type (e.g., on-site appointments or off-site appointments); the reason for the appointment; keywords for the appointment; date ranges for the appointment (e.g., appointments within a specified date range, days remaining to an appointment deadline, or appointments scheduled past deadlines); status of the appointment (e.g., all appointments, outstanding appointments, or completed appointments); and/or the stage of the appointment, such as pending appointments (e.g., an upcoming appointment that has not passed the deadline date), past due appointments (e.g., deadline date has come and gone), completed appointments (e.g., appointment was resolved and patient was seen), or not completed appointment (e.g., appointment was resolved and patient was not seen). In addition, the system may automatically schedule an appointment based upon a first available opening instead of a user searching for an open date.

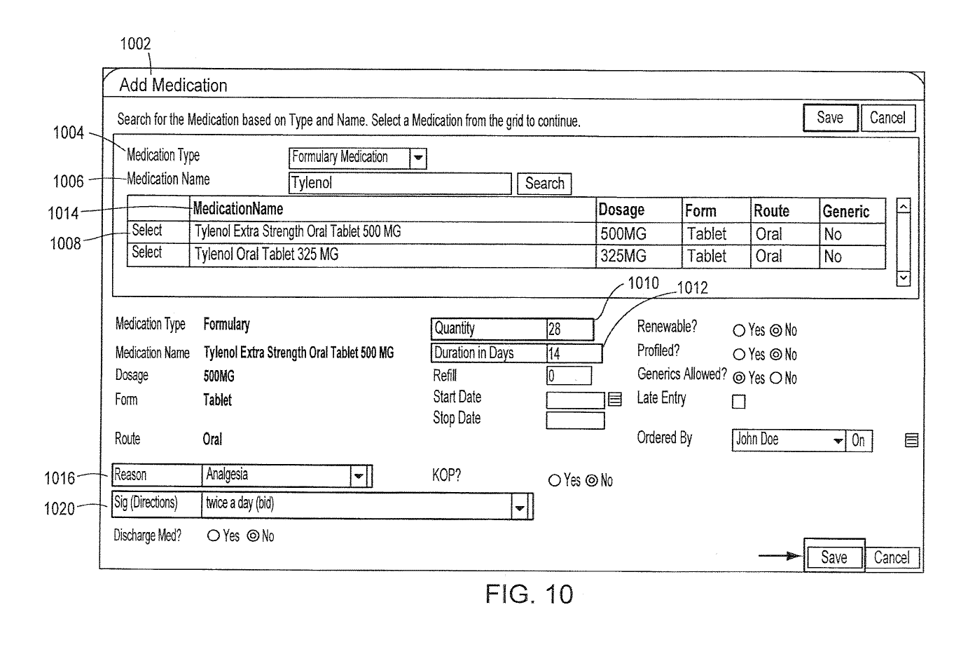

An aspect of the present invention may include any current medications at the time of the initial intake screening and process or the history and physical examination. In addition, prescribed medications after the initial intake or the history and physical examination may be recorded, as discussed in more detail below in regards to FIG. 10. Medications can be accessed from within the patient record. Individual 702 and intake should be selected to retrieve medication information. Historical medication functionality can include, among others, a list of the medications, medications associated with a condition, and ability to add new medications. Prescription medication functionality may have a list of prescription medications along with a detailed view of a single medication. In addition, it should be appreciated that capability may be provided to view medication allergies, add a new medication, and mark a medication as no longer active.

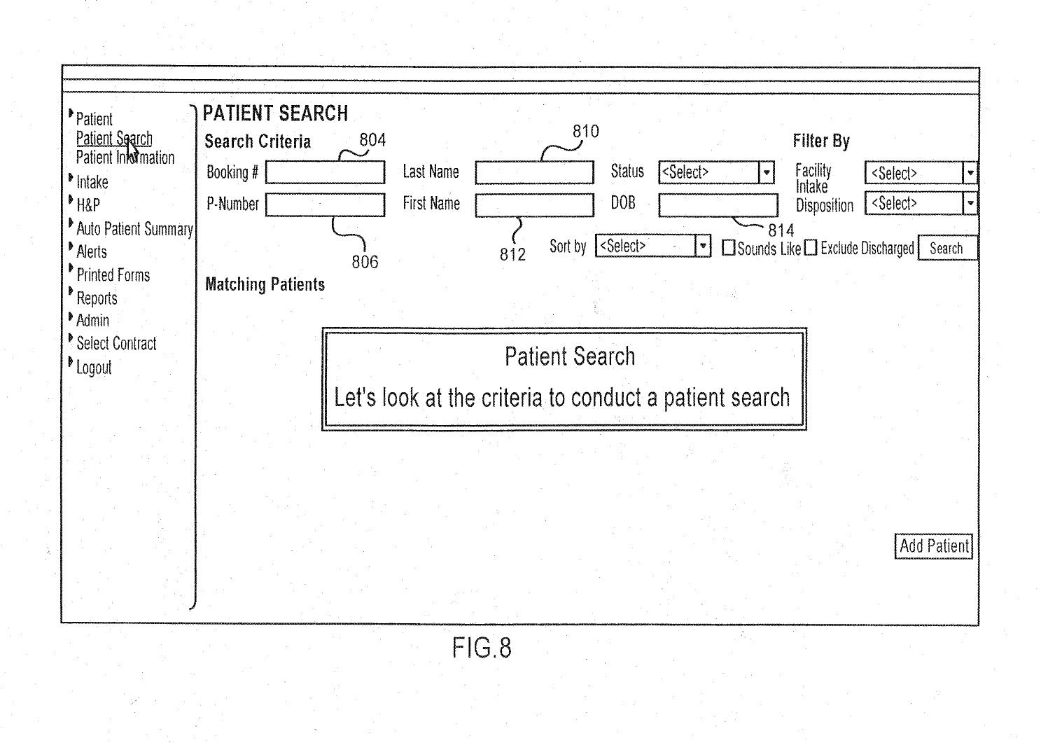

FIG. 8 presents in more detail aspects of the present invention allowing the user to identify and search for an individual. The patient identification and search functionality can allow each individual to be uniquely identified and found through the use of one or more identification numbers. For example, the identification numbers may include state id number, booking number 804, prison numbers 806, and visit identification numbers, among others. In addition, individuals that have previously been at the same facility should be identified by the same identification number so that previous information can be accessed. Further, a history of changes to demographic information and multiple arrest information can also be stored in the database. Once data has been imported, a person can be found by searching on first 812 and last name 810 or one of the unique identifiers.

Additional aspects of the present invention may provide the flexibility for the user to view and print reports with parameters they specify based on the specific data captured during the initial intake and screening process and the history and physical exam. The parameters may include, for example, date ranges, medication that may need to be renewed, current medication lists for an individual, labs and/or imaging diagnostics that may need to be ordered, test results that may need to be reviewed, the status of an intake (e.g., intakes and screenings that are not completed), and upcoming appointments, among other report parameters. Further, the user may select a printed form from a list of forms that were added during the initial intake and screening process or the history and physical exam.

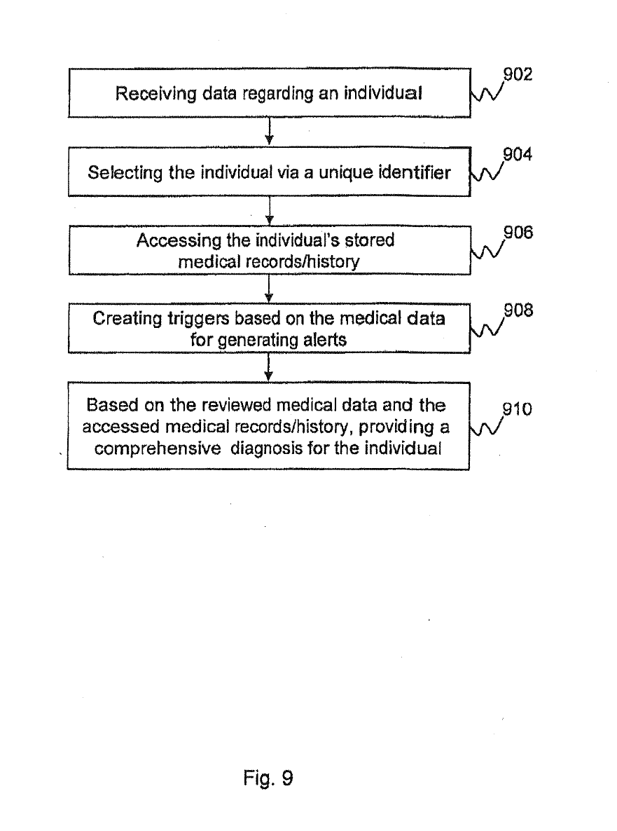

In one aspect of the present invention, an individual's stored medical records/history may be accessed in emergency or follow-up care involving the individual, as shown, for example, in FIG. 9.

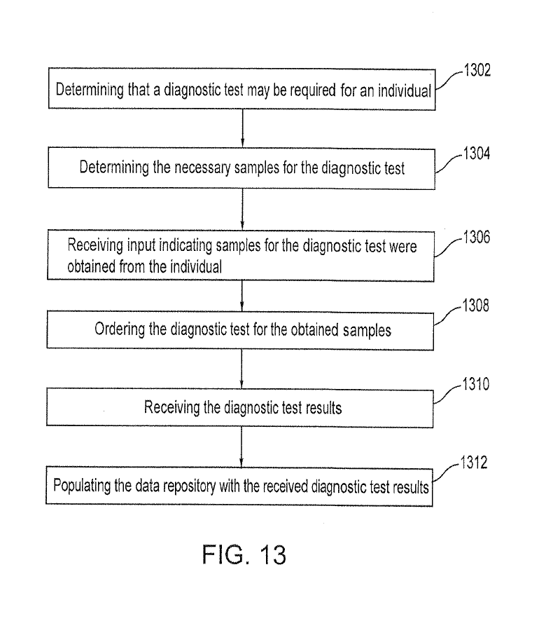

The user may receive medical data regarding an individual 902. For example, the user may select an individual via a unique identifier 904 and/or the user may access the individual's stored medical records/history 906. It may be possible to create triggers based on the medical data for generating alerts 908. These alerts may ensure consistent follow-up activities, such as ordering diagnostic tests for the individual 902, and may help guide the healthcare personnel through follow-up activities involving the individual. Further, a comprehensive diagnosis for the individual may be provided based upon the received medical data and the accessed medical records/history 910. The comprehensive diagnosis may include a problem list, allergies, upcoming appointments, and current medications, among others. Moreover, the comprehensive diagnosis may include prescribing and/or adding medications for the individual, as illustrated, for example, in FIGS. 10-12, in addition to ordering diagnostic tests for the individual, as illustrated in FIGS. 13-15.

Referring now to FIG. 10, illustrated is an example of adding medication to the medication list for an individual in accordance with an aspect of the present invention. As discussed above in reference to FIG. 7, medications for an individual may be accessed from within the patient record. Thus, for adding one or more medications to the list in a patient's record, a user may select the add medication tab 1002 from within the patient record. The user may select the type of medication 1004, e.g., formulary or all medications, and the medication name 1006 for adding to the patient's record. In addition, and/or alternatively, the user may also search for medications by entering a portion of a medication name 1006 and/or the complete medication name 1006.

A list of medication names 1014 and/or dosage amounts for each medication may be displayed based upon the search results and/or the information entered by the user. The list of medication names 1014 and dosage amounts may aid the user in selecting the correct medication and/or dosage amount for prescribing to the individual 1008. In addition, the user may also select the quantity 1010 of the medication and the duration of days 1012 the individual should take the selected medication 1008. Moreover, the user may enter reasons 1016 for prescribing the medication, such as analgesia, and provide directions 1020, e.g., twice a day, for taking the prescribed medication.

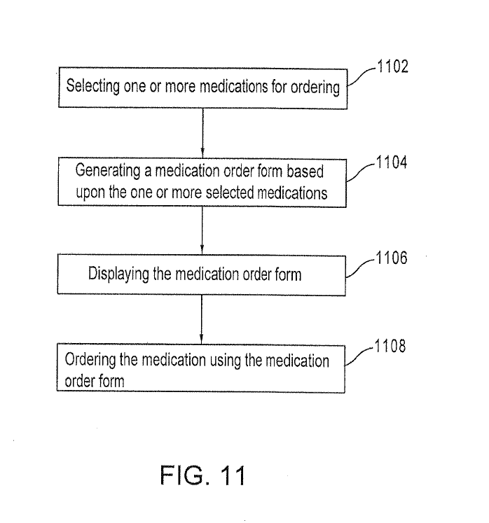

In an optional aspect, the user may provide additional information when adding medication to an individual's patient record. For example, the user may also include whether to discharge the medication, the start date for taking the medication, whether generics are permitted, whether the medication may be refilled and, if so, how many times, and when the medication was ordered, among other additional information relating to the medication. It should be appreciated that the additional information discussed above may comprise default values based upon the type of medication selected and/or may be added by the user if needed. Moreover, it should be appreciated that the user may use the system for ordering the newly added mediation, as illustrated in FIG. 11.

Referring now to FIG. 11, illustrated is an example flow diagram for ordering medication, in accordance with aspects of the present invention. The user may select one or more medications for ordering from a pharmacy. The one or more medications may be a new prescription, a medication inputted during the history and physical examination, and/or a medication that the individual is currently taking. In an aspect, the user may search for medications that may need to be ordered. Search criteria may include, for example, a date for the medication, such as the order date, the start date, end date, the discontinue date, and/or the renewal date for the medication, among other medication search criteria. The user may enter a date range and/or use a calendar function for selecting a date range and search for medications which may be close to and/or up for renewal. It should be appreciated that the user may select one or more medications for ordering for an individual or for a group of individuals.

The user may also generate a report with a list of medications that may be ordered and/or renewed for one or more individuals. In addition and/or alternatively, the user may be notified via an alert, for example, that medications should be ordered for the individual and/or are up for renewal. As discussed above in reference to FIG. 9 (902), triggers based upon the individual's medical data may be used for generating alerts. Thus, the user may receive alerts indicating that one or more medications should be ordered for the one or more individuals based upon the individual's medical data.

A medication order from may be generated 1104 and displayed 1106, based upon the one or more medications selected for ordering. For example, the medication order form may include, for example, the medication name, the dosage amount, the form of the medication, directions for taking the medication, the start and end date for taking the medication, renewal instructions for the medication, the discontinuation date for the medication, and/or the status of the medication, such as current or expired.

The selected medication may be ordered using the medication order form 1108. For example, the user may select a medication listed on the medication order form 1108 and select a button for faxing the medication to a pharmacy for filling. Thus, the user may directly order the selected medications from the medication order form 1108. In addition, the user may be able to provide additional comments, such as instructions to the pharmacy, when faxing the order. It should also be appreciated that the user may send the medication order form to the pharmacy via other communication methods, such as electronic mail, among other forms of communication. In one aspect, the system may automatically generate a medication order form and/or order the medication based upon pre-defined triggers in the individual's medical data, such as a renewal date and/or during a period of time, among other pre-defined triggers.

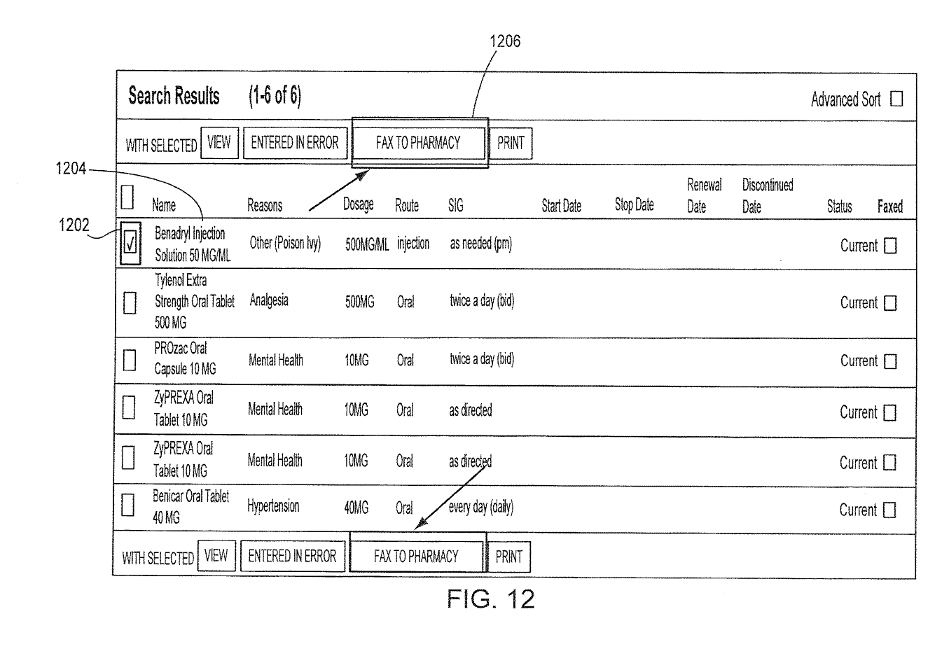

FIG. 12 is an example of ordering of medication in accordance with an aspect of the present invention. A list of search results 1204 for medications that may be ordered, e.g., new prescriptions and/or medications that need a refill may be displayed. The search results list 1204 may include the medication name, the dosage amount, the form of the medication, directions for taking the medication, the start and end date for taking the medication, renewal instructions for the medication, the discontinuation date for the medication, and/or the status of the medication, such as current or expired. The user may select a medication for ordering 1202 and fax 1206 the selected medication to a pharmacy for filling. It should be appreciated that the user may select more than one medication for ordering. In addition, the user may select medications for more than one individual for ordering. Thus, the user may use the system to directly fax medication orders to a pharmacy.

In an aspect, the system may track medications that an individual may be currently taking and generate an alert, e.g., a red flag, a stop sign, and/or alarm, if the medication requested for ordering either conflicts with one or more medications the individual may be taking and/or is duplicative of one or more medications that the individual may be taking.

In addition, follow-up activities, such as ordering diagnostic tests for the individual may be required. Referring now to FIG. 13, therein illustrated is an example flow diagram for ordering diagnostic tests for an individual in accordance with an aspect of the present invention. The method may include determining that one or more diagnostic tests for an individual may be required 1302. The user may make the determination during the initial intake and/or the comprehensive diagnosis. For example, an alert may be triggered indicating that one or more diagnostic tests may be required based upon data entered during the comprehensive diagnosis of the individual.

In addition and/or alternatively, the user may search for one or more diagnostic tests that may be required for the individual. The user may search, for example, by test status (e.g., outstanding, ordered, pending review, rescheduled, past due), test type (e.g., imaging, stat, labs, reference, or point of care (POC)), dates for the test (e.g., date the test was scheduled for and/or the date the test was ordered), and the individual who ordered the test, among other search criteria. A report may be generated based upon the search criteria with a list of diagnostic tests that should be ordered, e.g., outstanding and/or are past due. Thus, the user may select one or more diagnostic tests which may be necessary as follow-up activities as part of the individual's comprehensive medical evaluation.

The method may also include determining the necessary samples for the diagnostic test 1304. For example, the diagnostic test may require a sample of the individual's blood and/or an image, such as X-ray. The method may additionally include receiving input indicating that the required samples for the diagnostic test were obtained from the individual 1306. For example, an individual's patient record may be updated to indicate that the appropriate samples were obtained, the date the samples were obtained, and the individual who obtained the samples. It should be appreciated that samples may be obtained for one or more individuals at a time, and therefore, the system may be updated to indicate that one or more individuals' samples have been received.

The method may further include ordering the diagnostic test for the obtained samples 1308. The user may select one or more diagnostic tests for ordering from a laboratory. In one aspect, the user may order diagnostic tests prior to obtaining the necessary samples and forward the samples to the laboratory upon receipt of the samples. Moreover, the method may include receiving the diagnostic test results 1310 and populating the data repository with the received the diagnostic test results 1312. In an aspect, the test results from an outside laboratory may automatically interface into the data repository updating the patient record. Therefore, as the test results are received, the patient record may be automatically updated without the user having to enter the received test results. It should be appreciated, however, that the user may input the received laboratory results, for example, if the diagnostic test was performed by the individual and/or performed on-site.

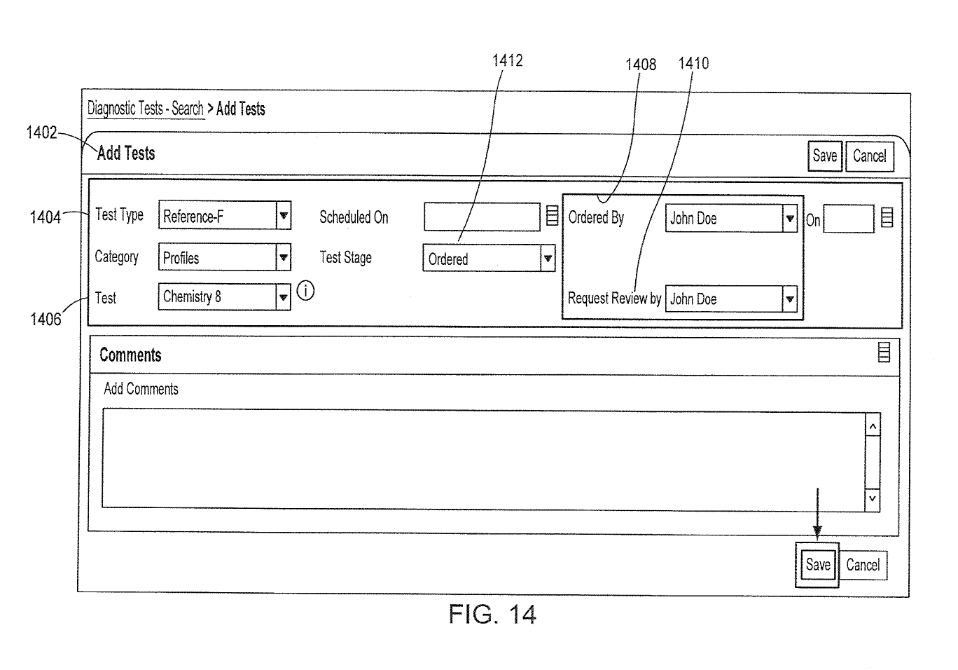

Referring now to FIG. 14, therein illustrated is an example of adding a diagnostic test to a patient record, in accordance with an aspect of the present invention. The user may select the add tests button 1402 to add one or more diagnostic tests, such as labs and/or imaging tests, to the patient record. The user may select the test type 1404 (e.g., imaging, stat, labs, reference, or POC) and the test name 1406. In addition, the user may select the test type 1404 and the test name 1406 from a drop-down menu, and/or alternatively, the user may enter in the appropriate diagnostic test information into the system. The user may also select the practitioner, such as the physician and/or nurse, who ordered the test 1408 and the practitioner who should review the test results 1410. The test results may be reviewed by the practitioner who ordered the test or by someone other than the ordering practitioner. In addition, the user may select the test stage 1412. The test stage 1412 may include, for example, ordered, outstanding, results past due, or rescheduled, among other test stages.

In one aspect, the user may add the same diagnostic test for more than one individual. For example, when an individual first arrives at the correctional facility, the individual may be required to have a purified protein derivative (PDD) skin test (a tuberculosis skin test). The user may search for a list of patients that may be required to take the PDD test. For example, the user may generate a list of new patients and determine whether the patient should have a PDD test ordered. The user may select the names of the patients who should have the PDD test added to the patient's medical records. The PDD test may be ordered, as discussed above in reference to FIG. 13, for the selected patients. Thus, the user may be capable of updating more than one individual's medical record without having to input the same test for each individual.

Referring now to FIG. 15, therein illustrated is an example of inputting results of a diagnostic test into a patient record, in accordance with an aspect of the present invention. In an aspect, the test details page 1502 may be used to receive and display the diagnostic test results. The test details page 1502 may include a diagnostic test information section 1504 for displaying the test information for the diagnostic test. Test information may include, for example, the test type and test category, the test name, the date the test was scheduled, the test stage (e.g., results past due, completed), the practitioner who ordered the test and the date the test was ordered, the practitioner who obtained the test results and the date the results were received, and the practitioner who should review the test results, among other test information. If more than one diagnostic test is listed and/or more than one test result is received, the user may select to which diagnostic test to add the test results.

The test details page 1502 may also include a results section 1506 for receiving and displaying the test results. The results section 1506 may include the type of the results received 1508, such as normal or abnormal. If the type of results received 1508 is abnormal, or if a test was performed that requires a practitioner's review, the review box 1512 may be selected for a practitioner to review the received test results. The system may generate an alert and/or notification notifying the practitioner that test results are available for the practitioner's review. For example, after a PDD test is performed, there may be more than one individual whose skin test is ready for review by a practitioner. The system may generate a list of individuals whose tests are ready for review and notify the practitioner of the list.

In one aspect, if the test results are normal, a report may be generated with all of the normal test results allowing a practitioner to review the test results in bulk without having to review each test result individually. Upon review of the test results, the user may update the diagnostic test stage to indicate the test is completed and the review has been performed.

The result section 1506 may additionally include a result box 1508 where the test results may be entered. In an aspect, the test results may be automatically entered into the patient's medical record. For example, if the test results are analyzed at an outside laboratory, when the test results are sent from the laboratory, the test results are automatically entered into the result section 1508 and the result type 1506 is selected. In an alternative aspect, the user may enter in the test results if the test was performed by the user and/or on-site, e.g., reading a PDD skin test. The test details page 1502 may also include a comments section 1514 for additional comments regarding the test results.

It should be appreciated that aspects of the present invention may be used for follow up activities while preserving the individual confidentiality. The specific data captured during the initial intake and screening process and the history and physical exam may be extracted to preserve the individual's confidentially and complied to generate reports or studies on the data. For example, studies may be conducted on illnesses effecting different regions of the country, illnesses effecting different populations of individuals, comparing how an illnesses effects a population in one area of country versus another area of the country, among others.

Further, it should be appreciated that aspects of the present may be used in helping to facilitate an individual's reentry into the community. For example, once an individual leaves a correctional facility, they may need continuing medical treatments. Aspects of the present invention may facilitate health information exchange with federal governments, local governments, or health providers, among others.

Aspects of the present invention provide benefits and advantages that include the ability to capture the current health state of an individual in a central location making the information readily available clinicians, either on-site or off-site of the correctional facility.

Further, the present invention allows for consistent medical treatment by asking the same detailed questions which generate the same alerts for follow up treatments. In addition, the present invention provides risk management by ensuring the proper medical treatment is given to the individual by using pre-defined triggers to generate alerts based on specific data captured. Also, the present invention provides comprehensive diagnosis of an individual as opposed to encounter diagnosis.

Additionally, the present invention allows for flexibility. The present invention may be used in state or federal correctional facilities. For example, the present invention may be used in prisons or jails, among others. The present invention may be modified to follow state specific issues including but not limited to, laws, rules, procedures, or recommendations. Further, as the law involving correctional health care changes, the system can easily be updated and modified to incorporate those changes. Moreover, the present invention can be used for various contracts with correctional facilities having different requirements, rules, or procedures, among others for health care treatments.

Further, it will be appreciated by those of ordinary skill in the art, that the present invention may be implemented in a single facility, or may be shared among several facilities.

Example aspects of the present invention have now been described in accordance with the above advantages. It will be appreciated that these examples are merely illustrative of the invention. Many variations and modifications will be apparent to those skilled in the art

Moreover, while numerous aspects of the system and method of the present invention have been described in relation to providing health care services for incarcerated individuals, it is within the scope of the present invention to apply the system and method of the present invention with any medical procedure, particularly new medical treatments that are not widely practiced for the reasons explained above. Other aspects will be apparent to those skilled in the art form a consideration of the specification or from a practice of the invention disclosed herein. It is intended that the specification and the described examples are considered exemplary only, with the true scope of the invention indicated by the following claims.

What is claimed is:

1. A method for medication ordering, the method comprising:
selecting one or more medications for ordering;
generating a medication order form based upon the one or more medications selected for ordering;
displaying the medication order form; and
ordering the one or more medications using the medication order form.

2. The method of claim 1, wherein generating the medication order form further comprises automatically generating the medication order form based upon medical data for an individual.

3. The method of claim 1, wherein ordering the medication further comprises one of faxing the medication order form to a pharmacy and sending the medication order form via electronic mail to the pharmacy.

4. The method of claim 1, wherein the one or more medications is one of a new prescription for an individual or a medication the individual is currently taking.

5. A system for medication ordering, the system comprising:
a module for selecting one or more medications for ordering;
a module for generating a medication order form based upon the one or more medications selected for ordering;
a module for displaying the medication order form; and
a module for ordering the one or more medications using the medication order form.

6. The system of claim 5, wherein the module for generating the medication order form further comprises a module for automatically generating the medication order form based upon medical data for an individual.

7. The system of claim 5, wherein the module for ordering the medication further comprises one of a module for faxing the medication order form to a pharmacy and a module for sending the medication order form via electronic mail to the pharmacy.

8. The system of claim 5, wherein the one or more medications is one of a new prescription for an individual or a medication the individual is currently taking.

9. A system for medication ordering, the system comprising:
a processor;
a user interface functioning via the processor; and
a repository accessible by the processor;
wherein one or more medications are selected for ordering;
wherein a medication order form is generated based upon the one or more medications selected for ordering;
wherein the medication order form is displayed; and
wherein the one or more medications are ordered using the medication order form.

10. A method for receiving diagnostic test results for an individual, the method comprising:
determining that a diagnostic test is required for the individual;
determining necessary samples for the diagnostic test;
receiving input indicating the samples for the diagnostic test were obtained from the individual;
ordering the diagnostic test for the obtained samples;
receiving the diagnostic test results for the ordered diagnostic test; and
populating the data repository with the received diagnostic test results.

11. The method of claim 10, wherein the test results interface automatically with the data repository upon receipt of the test results.

12. The method of claim 10, wherein determining that the diagnostic test is required further comprises:
performing a search indicating that one or more diagnostic tests are required;
generating a report with the search results; and
determining based upon the report the diagnostic test that are required.

13. The method of claim 12, wherein the search is performed based upon the status of the diagnostic test.

14. The method of claim 13, wherein the status of the diagnostic test comprises one of an outstanding status, a pending review status, an ordered status, a rescheduled status, and a past due status.

15. A system for receiving diagnostic test results for an individual, the system comprising:
a module for determining that a diagnostic test is required for the individual;
a module for determining necessary samples for the diagnostic test;
a module for receiving input indicating the samples for the diagnostic test were obtained from the individual;
a module for ordering the diagnostic test for the obtained samples;
a module for receiving the diagnostic test results for the ordered diagnostic test; and
a module for populating the data repository with the received diagnostic test results.

16. The system of claim 15, wherein the test results interface automatically with the data repository upon receipt of the test results.

17. The system of claim 15, wherein the module for determining that the diagnostic test is required further comprises:
a module for performing a search indicating that one or more diagnostic tests are required;
a module for generating a report with the search results; and
a module for determining based upon the report the diagnostic tests that are required.

18. The system of claim 17, wherein the search is performed based upon the status of the diagnostic test.

19. The system of claim 18, wherein the status of the diagnostic test comprises one of an outstanding status, a pending review status, an ordered status, a rescheduled status, and a past due status.

20. A system for receiving diagnostic test results for an individual, the system comprising:
a processor;
a user interface functioning via the processor; and
a repository accessibly by the processor;
wherein a determination is made that a diagnostic test is required for the individual;
wherein necessary samples are determined for the diagnostic test;
wherein input is received indicating the samples for the diagnostic test were obtained from the individual;
wherein the diagnostic test is ordered for the obtained samples;
wherein the diagnostic test results are received for the ordered diagnostic test; and
wherein the data repository is populated with the received diagnostic test results.
